(19) United States
(12) Patent Application Publication
(10) Pub. No.: US 2005/0221007 A1
(43) Pub. Date: Oct. 6, 2005

(54) Surface preparation

(75) Inventors: Steven J Harris, Bradley Stoke (GB); Simon R Church, Almonds Bury (GB)

Correspondence Address: NIXON & VANDERHYE, PC, 901 NORTH GLEBE ROAD, 11TH FLOOR, ARLINGTON, VA, 22203, US

(73) Assignee: BAE SYSTEMS plc, London (GB)

(21) Appl. No.: 10/519,945

(22) PCT Filed: Nov. 18, 2004
(86) PCT No.: PCT/GB04/04873

§ 371 Date: Dec. 29, 2004

(30) Foreign Application Priority Data
Nov. 20, 2003 (GB) 0326971.9
Nov. 20, 2003 (EP) 032257337.0

(51) Int. Cl. B05D 1/40; B05D 3/00

(52) U.S. Cl. 427/299; 427/331

(57) ABSTRACT

A method of preparing the surface of a coated structure for the application of an overcoat is described. The method comprises cleaning the surface of the coat with cleaning solution and applying an oxidising agent to the surface.

### FIELD

This invention relates to a method of preparing the surface of a coated structure for the application of an overcoat. In particular, but not exclusively, the invention relates to a method of preparing the surface of an aircraft or aerospace structure for the application of a overcoat.

### BACKGROUND

In the aircraft and aerospace industry a structure such as an aircraft frame is initially coated, (e.g. with a paint or primer) before the application of an overcoat (e.g. a paint topcoat). The structure may be metallic (e.g. aluminium) or may be formed from a composite material (e.g. a carbon fibre composite with an epoxy matrix) and may be pre-treated, for example by grit blasting, etching and/or anodising before the initial coat is applied. Composite materials may be used on the leading edge of a wing of an aircraft frame (e.g. on an Airbus) or for the wings themselves (e.g. on a Typhoon).

In the aircraft and aerospace industry rather than applying the overcoat to a fresh initial coat, the structure (e.g. the aircraft frame) may be put through various tests or trials once the initial coat has been applied. These may include trials to check that the structure is fully operational, for example for an aircraft checking that the radar, undercarriage and engines are fully operational. The trials may be performed over several days or weeks and result in the surface of the initial coat of the structure being exposed to contaminants such as hydrocarbon-based contaminants, lubricants and hydraulic fluid. In addition the surface of the initial coat may be “aged” by exposure to light, particularly UV light. The surface of the initial coat can therefore become contaminated and/or aged, at least to a moderate degree.

Before the overcoat (e.g. a paint topcoat) is applied over the surface of the initial coat, the contaminated and/or aged initial coat surface needs to be treated for the overcoat to adhere well. Considerations when treating the initial coat include not piercing the initial coat (which is typically a protective primer or undercoat) and not damaging the structure itself. Health and safety and environmental issues also need to be considered, such as limiting the exposure of personnel and the environment to potentially toxic materials.

Until now, approaches have been used involving cleaning the surface of the initial coat with a volatile organic cleaning fluid (e.g. butanone, acetone or trichloroethane-based cleaning fluids) before manually sanding the coat to produce a fresh surface for the overcoat to adhere to. Manual sanding is used rather than an automated approach, such as automated sanding, to avoid piercing the coat and to avoid damage to the underlying structure, particularly if the structure is formed from a composite material. Disadvantageously, such approaches are time consuming (it can take around 50 man-hours to sand a single aircraft frame) and therefore costly. Furthermore, and undesirably, such approaches expose personnel and the environment to potentially toxic materials, including the volatile organic cleaning fluids and the “dust” removed by the sanding which in the case of a primer paint may include chromate.

The present invention seeks to provide an improved method of preparing the surface of a coated structure for the application of an overcoat.

### SUMMARY

Accordingly, viewed from a first aspect the invention provides a method of preparing the surface of a coated structure for the application of an overcoat, the method comprising: cleaning the surface of the coat with cleaning solution; and applying an oxidising agent to the surface.

Advantageously, by applying an oxidising agent a surface to which the overcoat can adhere is provided. Without wishing to be bound by theory, it is believed that the oxidising agent oxidises unsaturated groups (carbon double bonds) in materials on the surface of the coat, such as unsaturated groups in organic binders found in paints. It is believed the resulting hydroxy and carbonyl groups provide functional groups to which the overcoat can adhere.

Accordingly any suitable oxidising agent may be used. In particular embodiments peroxide is used. Hydrogen peroxide is particularly suitable and advantageously has environmentally friendly by-products.

Advantageously, methods performed in accordance with embodiments of the invention are less time consuming and less costly than known approaches. In addition, methods performed in accordance with embodiments of the invention reduce the exposure of personnel and the environment to toxic materials.

Viewed from another aspect the invention provides a method of applying an overcoat to the surface of a coated structure, the method comprising: preparing the surface in accordance with the above defined method; and applying the overcoat.

Viewed from a further aspect the invention provides a coated structure wherein the structure has been treated in accordance with the above defined methods.

Viewed from yet another aspect the invention provides a cleaning kit for preparing the surface of the coat of a coated structure for the application of an overcoat, the kit comprising a cleaning solution and an oxidising agent.

### BRIEF DESCRIPTION OF THE DRAWINGS

Embodiments of the present invention will now be described, by way of example only, with reference to the accompanying drawings, in which:

FIG. 1 schematically illustrates a coated structure to which an overcoat has been applied;

FIG. 2 schematically illustrates a coated structure; and

FIG. 3 shows the steps of a method performed in accordance with an embodiment of the present invention.

### DETAILED DESCRIPTION

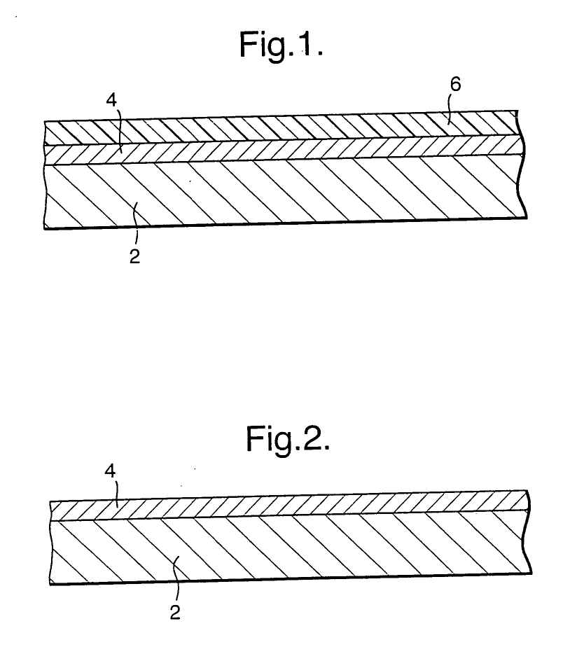

FIG. 1 schematically illustrates a coated structure with an overcoat. The structure 2 is coated with coat 4 which in turn is coated with overcoat 6. The substrate or structure 2 may be any structure, but in particular embodiments is an aerospace or aircraft structure, including aircraft frames (both fixed wing and rotary wing) and other airborne structures. The structures may be metallic (e.g. aluminium, aluminium alloys, titanium alloys and steels) or formed of a composite material (e.g. a carbon fibre composite). The initial coat or coat 4 is typically an undercoat, for example a paint or a primer such as a chromate primer. In particular embodiments the coat 4 is an epoxy primer or a polyurethane primer. The overcoat 6 is typically paint, for example a topcoat paint and/or a polyurethane paint.

Generally, the coat 4 is applied to the structure 2 and the overcoat 6 is then applied to the coat 4, often several days or weeks later (depending on the particular tests or trials that are performed). FIG. 2 schematically illustrates a structure 2 coated with coat 4 (i.e. a coated structure) before overcoat 6 has been applied.

Optionally, the structure 2 may be treated in some way before the coat 4 is applied. For example, a metallic structure may be anodised. In one particular embodiment a metallic structure (e.g. aluminium) is grit blasted, etched (e.g. with chromic acid) and anodised (e.g. in chromic acid) before the application of the coat 4 (e.g. a chrome based primer paint).

In certain embodiments, the optional anodised layer (not illustrated in FIGS. 1 and 2) has a width or depth in the range from about 1 μm to about 3 μm. The coat 4 may have a width in the range from about 20 μm to about 30 μm and in one particular example is 25 μm. The overcoat 6 may have a width in the range from about 30 μm to about 40 μm and in one particular example is 35 μm.

It is often necessary to treat the coat 4 prior to the application of the overcoat 6. Typically, this is to ensure that the coat 4 is cleared of contaminants and has a surface to which the overcoat can adhere or bind well. Such a treatment is particularly used in applications where the coat 4 has aged (by exposure to light, for example) and/or has been exposed to contaminants.

One particular application is in the aircraft and aerospace industry where the coated structures (e.g. an aircraft structure) are tested for several days or weeks. The tests can include checking that the various aircraft systems (e.g. radar, undercarriage, engines) are fully operational. After these tests the coat 4 typically has aged and has been exposed to aircraft/aerospace contaminants such as hydrocarbon-based contaminants (e.g. oils), lubricants and hydraulic fluid. Environmental ageing, such as UV induced chalking is particularly observed in chromate-loaded epoxy-based primer paints, commonly used as the coat 4 in the aircraft and aerospace industry.

As mentioned above, until now a manual sanding technique has been used to prepare the surface of coat 4 for the application of the overcoat 6 and this is disadvantageous and undesirable in terms of cost, health and safety and environmental issues.

Particular embodiments of the present invention provide a method of preparing the surface of a coated structure for the application of an overcoat. That is to say, particular embodiments provide a method of preparing or treating the surface of coat 4 (shown in FIG. 2)—which may have aged and/or have been contaminated—for the subsequent application of the overcoat 6 (shown in FIG. 1). Such a treatment can be termed “surface reactivation” or “surface regeneration” (or “paint surface reactivation/regeneration” where the coat 4 is a paint).

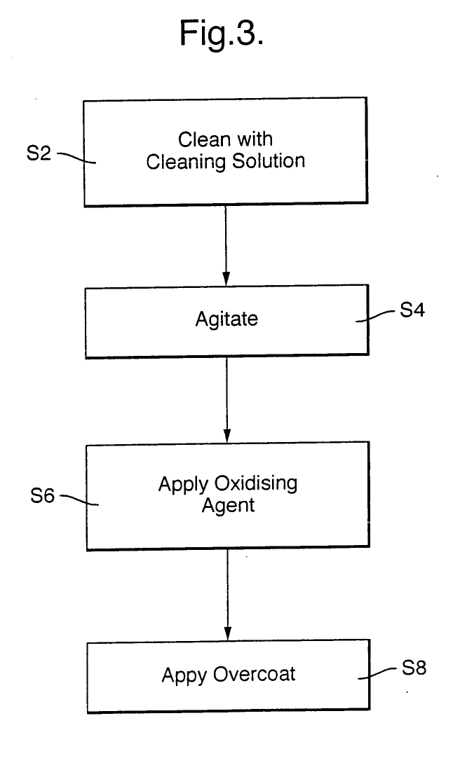

FIG. 3 shows the steps of a method performed in accordance with an embodiment of the present invention. At step S2 the surface of coat 4 of a coated structure is cleaned with cleaning solution. The cleaning solution may be any suitable cleaning solution, but in certain embodiments is an alkaline cleaner. The cleaning solution may be a water-based or aqueous cleaner. Advantageously, alkaline and water-based cleaners are more environmentally friendly and satisfy health and safety concerns better than known approaches which use organic-based cleaners including high volatile organic content cleaners.

In certain embodiments the following cleaning solutions may be used: Ardox 1900B; Ardox 6025; Ardox 6475; Ardox 6412; Ardox 140B; and CA0200. The Ardox cleaning solutions are available from Chemetall Plc and CA0200 is available from PRC DeSoto (a PPG Industries Company). Adrox 1900B has been found to give particularly good results.

The cleaning step S2 may comprise soaking the surface of coat 4 with the cleaning solution, for example by applying the cleaning solution and leaving the solution in contact with the surface. The soaking may be performed for any suitable time and in particular embodiments the soaking is performed for a time in the range from about 30 seconds to about 5 minutes.

The cleaning step S2 may comprise agitating the surface of the coat 4 (e.g. by scrubbing or brushing). The agitation may be performed as part of the cleaning step (i.e. the agitation may be performed as the cleaning solution is applied to the surface of coat 4) or may be performed at step S4 after the surface has been soaked with the cleaning solution. In certain embodiments the agitation is for a time in the range from about 30 seconds to about 20 minutes, in others from about 2 minutes to about 10 minutes.

Typically, the agitating comprises agitating the surface of coat 4 with a brush, although other types of agitation may be used (e.g. with a pad or mop or by ultrasonic agitation). In particular embodiments brushes with soft bristles or bristles formed from man made fibres are used. Suitably the agitation time may be optimised for the agitation type, for example a longer agitation time may be used with a softer brush bristle.

After the surface of coat 4 has been cleaned and optionally agitated any residual cleaning solution may be removed, for example by washing. In one embodiment residual cleaner is removed by pressure washing. The surface of coat 4 may be rinsed with water, and in one particular embodiment is rinsed with deionised water.

At step S6 an oxidising agent is applied to the surface of coat 4. Any suitable oxidising agent may be used, in particular those which oxidise unsaturated groups (carbon double bonds) to hydroxy and carbonyl groups. Suitable oxidising agents include KMnO₄, K₂Cr₂O₇, O₃ and OsO₄. Optionally an air plasma may be used as the oxidising agent.

In particular embodiments a peroxide (i.e. any substance containing a chemical with the peroxide ion (O₂²⁻)) is used as the oxidising agent. In one example hydrogen peroxide is used. Typically the oxidising agent (e.g. peroxide) is applied as a solution and may be applied to the coat surface by spraying the oxidising agent onto the surface. The oxidising agent application may be performed for any suitable time. In particular embodiments oxidising agent application is performed for a time in the range from about 1 minute to about 5 minutes.

In certain embodiments the peroxide is hydrogen peroxide. The hydrogen peroxide may have a concentration in the range from about 1% to about 10%. In one embodiment the peroxide is 3% hydrogen peroxide. Advantageously, the use of hydrogen peroxide is environmentally friendly because the by-products are oxygen and water.

After applying the peroxide, the surface of coat 4 may be rinsed with water, and in one particular embodiment is rinsed with deionised water.

Once the above steps have been performed the method of preparing the surface of coat 4 for the application of an overcoat is complete.

Embodiments of the present invention provide a method of applying an overcoat to the surface of coat 4 of the structure 2 after the coat has been prepared in accordance with steps S2 to S6. Accordingly at step S8 the overcoat 6 is applied. Typically the overcoat application is by spraying.

It will be appreciated that the relatively short time taken for the steps of embodiments of the present invention, when compared to prior approaches, represent a significant advantage (in terms of cost for example) which are in addition to the benefits in terms of environmental and health and safety concerns.

Embodiments of the present invention provide a cleaning kit for preparing the surface of the coat of a coated structure for the application of an overcoat. The kit may comprise two containers, with the cleaning solution in one container and oxidising agent in another container. The kit may also comprise agitating means, for example one or more brushes. The kit may also comprise instructions for use, including instructions concerning the process steps and the time each step should be performed.

The present invention will be further described, by way of example only, with reference to the following examples.

In these examples primer-coated aluminium panels were contaminated before being treated in accordance with the invention and tested.

Specifically, 15 cm by 7 cm, 3 mm thick aluminium panels were coated with PR205, a high solids chromate-loaded epoxy primer from PRC DeSoto. Each panel was then contaminated with one of three common aerospace/aircraft industry contaminants. The three contaminants used were a phosphate ester hydraulic fluid (Skydrol from Solutia), Mobil Oil (a typical saturated hydrocarbon) (specifically, Mobil Jet Oil II from Mobil Oil Corporation) and cetyl alcohol (C₁₆H₃₃OH, a lubricant commonly used on aerospace rivets). Three levels of contamination were used—heavy, medium and light—each based on the weight of contamination used. In each case the contaminant was applied over the surface of the primer coat. For heavy contamination 0.2 g of contaminant was used; for medium contamination 0.1 g of contaminant was used and for light contamination 0.05 g of contaminant. The panels were weighed before and after the application of the contaminant to check that the correct weight of contaminant had been applied.

Tests were also performed using a mixture of all three contaminants at the three levels of contamination.

The panels were left for 1, 3 or 7 days after application of the contaminant. The contaminated panels were then treated in accordance with an embodiment of the present invention as follows.

Step 1: soak the surface of the primer coat in the cleaning solution for a set time (1, 5 or 15 minutes).

Step 2: agitate (brush) the surface of the primer coat using a soft brush for a set time (30 seconds or 1 minute).

Step 3: remove residual cleaning solution by pressure washing for 1 minute.

Step 4: rinse the surface of the primer coat with de-ionised water for 1 minute.

Step 5: apply 3% hydrogen peroxide solution to the surface of the primer coat for a set time (typically 5 minutes).

Step 6: rinse the surface of the primer coat with de-ionised water for 1 minute.

Step 7: allow the primer coat to dry for 1 hour at 40° C.

The panels were then painted with a topcoat paint (specifically, CA8311 which is a polyurethane topcoat paint supplied by PRC DeSoto) and allowed to dry for 7 days.

The panels were then tested (as “dry” tests) using two industry standard ISO tests. The first test, ISO 4624 involves gluing a small puck to the painted surface and measuring the force needed to remove it. This test gives a numerical value which represents the adhesion strength between the painted surfaces. The second test, ISO 2409 (the “cross hatch” test) involves scoring a grid into the surface of the painted panel and a visual check to give the surface an integer score from 0 to 5 which represents its quality, 0 being good surface quality and 5 being poor surface quality.

The panels were then immersed in de-ionised water at 40° C. for 2 weeks before the two tests were repeated (as “wet” tests).

For each example a control was kept which was not contaminated and not cleaned (i.e. untreated or “as painted”, with no contamination). The test results for the cleaned panels were compared with those for the control panels. The results are shown in the following table.

| Initial | | Cleaning | Oxidising | Soaking | Agitation | % Average | % Average |
|---|---|---|---|---|---|---|---|
| Coat 4 | Coat 6 | Solution | Agent | Time | Time | Dry | Wet |
| PR205 | CA | Ardox 6025 | 3% | 1 min | No | 116.3 | 63.4 |
| | 8311 | | H₂O₂ | | Agitation | | |
| PR205 | CA | Ardox 6025 | 3% | 5 mins | No | 106.6 | 61.5 |
| | 8311 | | H₂O₂ | | Agitation | | |
| PR205 | CA | Ardox 6025 | 3% | 15 mins | No | 79.7 | 68.0 |
| | 8311 | | H₂O₂ | | Agitation | | |
| PR205 | CA | Ardox | 3% | 1 min | No | 182.0 | 225.8 |
| | 8311 | 1900B | H₂O₂ | | Agitation | | |
| PR205 | CA | Ardox | 3% | 5 mins | No | 187.4 | 220.6 |
| | 8311 | 1900B | H₂O₂ | | Agitation | | |
| PR205 | CA | Ardox | 3% | 15 mins | No | 144.3 | 125.0 |
| | 8311 | 1900B | H₂O₂ | | Agitation | | |
| PR205 | CA | Ardox | 3% | 1 min | 30 | 112.0 | 78.0 |
| | 8311 | 1900B | H₂O₂ | | seconds | | |
| PR205 | CA | Ardox | 3% | 5 mins | 30 | 84.3 | 82.1 |
| | 8311 | 1900B | H₂O₂ | | seconds | | |
| CA 8311 | CA | Ardox | 3% | 1 min | 1 min | 91.4 | 88.6 |
| (on | 8311 | 1900B | H₂O₂ | | | | |
| PR205) | | | | | | | |
| CA 8311 | CA | Ardox | 3% | 1 min | 3 mins | 95.8 | 80.0 |
| (on | 8311 | 1900B | H₂O₂ | | | | |
| PR205) | | | | | | | |
| | | | | | Errors +/− | 16.6 | 14.0 |

These results show the average results of all of the tests under the specified conditions (i.e. average values for the tests performed at each contamination level and number of days of contamination and for each contaminant or contaminant mixture). The % Average Dry and % Average Wet test are ISO 4624 values for the test panel compared to the control (i.e. the pressure needed to remove the puck for the test panel divided by the pressure needed to remove the puck for the control). Values above 100% show results that are better than the uncontaminated/uncleaned (i.e. untreated or “as painted”) control panels. Values for contaminated but uncleaned test panels (not shown) are considerably lower than those shown in the table, typically less than 50% (i.e. values of less than 100% in the table still show positive results).

The first eight results in the table are for CA 8311 topcoat paint overcoating the PR205 primer. The last two results are for CA 8311 topcoat overcoating CA 8311 topcoat. The initial coat 4 (CA 8311) in the last two results itself is applied over a PR205 primer layer on the structure.

In all the tests the ISO 2409 (“cross hatch” test) gave a score of 0 (dry) or scores of 0 or 1 (wet) which are considered as passes for this test.

Although the invention has been described in relation to particular embodiments, it will be appreciated that the invention is not limited thereto, and that many variations are possible falling within the scope of the invention.

For example, in certain applications the coat 4 and the overcoat 6 may both be considered as topcoats, such as in the last two test results shown in the table above. That is to say embodiments of the invention may be used to prepare a topcoat for the application of a topcoat (i.e. re-painting). The invention also has application in fields other than the aircraft and aerospace industry, for example in naval, land vehicle, sub-assembly and field repair applications.

The scope of the present disclosure includes any feature or combination of features disclosed herein. Features from any claim or from the description may be combined with any other feature in any appropriate manner and not merely in the specific combinations enumerated.

1. A method of preparing the surface of a coated structure for the application of an overcoat, the method comprising:
cleaning the surface of the coat with cleaning solution; and
applying an oxidising agent to the surface.

2. A method according to claim 1, wherein the cleaning comprises soaking the surface of the coat with the cleaning solution.

3. A method according to claim 2, wherein the soaking is for a time in the range from about 30 seconds to about 5 minutes.

4. A method according to claim 1, wherein the cleaning comprises agitating the surface of the coat with the cleaning solution.

5. A method according to claim 4, wherein the agitating is for a time in the range from about 30 seconds to about 20 minutes.

6. A method according to claim 4, wherein the agitating is for a time in the range from about 2 minutes to about 10 minutes.

7. A method according to claim 4, wherein the agitating comprises agitating the surface with a brush.

8. A method according to claim 1, wherein the cleaning comprises soaking the surface of the coat before agitating the surface with the cleaning solution.

9. A method according to claim 1, wherein the cleaning solution is an alkaline cleaner.

10. A method according to claim 1, wherein the cleaning solution is a water-based cleaner.

11. A method according to claim 1, wherein the oxidising agent is peroxide.

12. A method according to claim 11, wherein the peroxide is hydrogen peroxide.

13. A method according to claim 12, wherein the concentration of the hydrogen peroxide is in the range from about 1% to about 10%.

14. A method according to claim 12, wherein the concentration of the hydrogen peroxide is 3%.

15. A method according to claim 1, wherein the applying the oxidising agent comprises spraying the oxidising agent onto the surface of the coat.

16. A method according to claim 1, wherein the coat is paint.

17. A method according to claim 1, wherein the coat is a primer.

18. A method according to claim 1, wherein the overcoat is paint.

19. A method according to claim 1, wherein the structure is metallic.

20. A method according to claim 1, wherein the structure is formed of a composite material.

21. A method according to claim 1, wherein the structure is an aircraft or aerospace structure.

22. A method of applying an overcoat to the surface of a coated structure, the method comprising:
preparing the surface of the coat in accordance with the method of any preceding claim; and
applying the overcoat.

23. (canceled)

24. A coated structure wherein the structure has been treated in accordance with the method of claim 1.

25. A coated structure according to claim 24, wherein the structure is an aircraft or aerospace structure.

26. A cleaning kit for preparing the surface of the coat of a coated structure for the application of an overcoat, the kit comprising a cleaning solution and an oxidising agent.
